(19) United States
(12) Patent Application Publication
(10) Pub. No.: US 2025/0266771 A1
(43) Pub. Date: Aug. 21, 2025

(54) POWER SUPPLY UNIT AND LOOP POWER SUPPLY SYSTEM

(71) Applicant: Delta Electronics (Shanghai) Co.,Ltd., Shanghai (CN)

(72) Inventors: Weiqiang ZHANG, Shanghai (CN); Xingkuan GUO, Shanghai (CN); Hongyang WU, Shanghai (CN)

(21) Appl. No.: 19/203,211

(22) Filed: May 9, 2025

Related U.S. Application Data
(63) Continuation of application No. 17/809,900, filed on Jun. 30, 2022.

(30) Foreign Application Priority Data
Jul. 15, 2021 (CN) 202110800546.5
Jan. 27, 2022 (CN) 202210099776.8

(51) Int. Cl. H02M 3/335; H02M 1/00; H02M 7/217

(52) U.S. Cl. CPC H02M 3/33584; H02M 1/0074; H02M 7/217

(57) ABSTRACT

The disclosure provides a power supply unit, including: a first high-frequency isolating converter including a first end connected to a first voltage, a second end and a third end; and a second high-frequency isolating converter including a first end connected to a second voltage, a second end and a third end, wherein the second end of the second high-frequency isolating converter and the second end of the first high-frequency isolating converter are connected in parallel to a first end of a first load, and the third end of the second high-frequency isolating converter and the third end of the first high-frequency isolating converter are connected in parallel to a second end of the first load. The disclosure further provides a loop power supply system having the power supply unit.

### CROSS-REFERENCE TO RELATED APPLICATIONS

This application is a Continuation Application of U.S. patent application Ser. No. 17/809,900, filed on Jun. 30, 2022, entitled “POWER SUPPLY UNIT AND LOOP POWER SUPPLY SYSTEM”, which claims priority under 35 U.S.C. § 119(a) on Patent Application No. 202110800546.5 filed on Jul. 15, 2021, in P.R. China, and Patent Application No. 202210099776.8 filed on Jan. 27, 2022, in P.R. China, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### FIELD

The disclosure relates to a redundant power supply system, and particularly to a power supply unit and a loop power supply system having the power supply unit.

### BACKGROUND

Research data of China Green Data Center Technology Committee show that a total power consumption of the Chinese Data Center in 2016 has exceeded 120 billion kilowatt hour. As service supported by the Data Center becomes more, computing load and scale of the Data Center still keep a high increase. Safe, reliable and uninterrupted operation of the Data Center depends on a high reliable power supply system. Therefore, multiple redundant power supply schemes are provided.

As shown in FIG. 1, FIG. 1 illustrates the traditional 2N redundant power supply system 100. In the power supply system 100, two 10 KV AC inputs are stepped down via line frequency transformer 101 and 102 respectively, and voltages after step-down are further converted into DC outputs via converters 111 and 112 respectively. Then the DC outputs of the converters 111 and 112 are connected to two inputs of a load 120 for powering the load 120, thereby realizing 2N redundancy. An AC bus connecting switch S is included between the two paths of power supply for avoiding influence of faults before an AC bus on the load. However, when there are faults on or after the AC bus, the load may face the case of powering from single side.

With continuous improvement of reliability of information data center (IDC), the case of powering from single side of the load for a long time gradually becomes unacceptable.

The prior art provides a powering method with phase-shifting transformers replacing the traditional line frequency transformer. FIG. 2 illustrates a power supply system 200 using phase-shifting transformers. As shown in FIG. 2, the power supply system 200 has two phase-shifting transformers 201 and 202, outputs of each phase-shifting transformer are divided into two groups, and each group is connected to an AC-DC converter (A2D). For example, the outputs of the phase-shifting transformer 201 are divided into two groups connected to converters 211 and 212, and the outputs of the phase-shifting transformer 202 are divided into two groups connected to converters 213 and 214. The two outputs of the two converters 211 and 212 are cross connected with the two outputs of the two converters 213 and 214 to power a load. That is, outputs of the converters 211 and 213 are connected together to an input terminal 221 of a load 220, and outputs of the converters 212 and 214 are connected together to an input terminal 222 of the load 220. Therefore, influence on the load caused by faults before the DC bus can be avoided through cross connection of the outputs of the converters, and then the load 220 can still be powered from both of the input terminals 221 and 222.

Although the power supply system 200 illustrated in FIG. 2, for example, can avoid the case of powering the load from a single input terminal of the load for a long time, since the phase-shifting transformer itself has a heavy weight, a large size and too many windings, the existing power supply system has the following deficiencies. (1) Due to connection of multiple windings between the phase-shifting transformer and the A2Ds, there are too many connection lines. (2) When the phase-shifting transformer has a fault, it is difficult to make direct maintenance in-situ, and time consumption is long. (3) The power supply system with an architecture of the phase-shifting transformer and the A2Ds has a large size, and a heavy weight.

Therefore, a redundant power supply system having a simple structure, less connection lines and easy for maintenance is required.

### SUMMARY

An object of the disclosure is to provide a redundant power supply system having a simple structure, less connection lines and easy for maintenance.

According to one aspect of the disclosure, a power supply unit is provided, including: a first high-frequency isolating converter including a first end connected to a first voltage, a second end and a third end; and a second high-frequency isolating converter including a first end connected to a second voltage, a second end and a third end, wherein, the second end of the second high-frequency isolating converter and the second end of the first high-frequency isolating converter are connected in parallel to a first end of a first load, and the third end of the second high-frequency isolating converter and the third end of the first high-frequency isolating converter are connected in parallel to a second end of the first load.

According to another aspect of the disclosure, a power supply system is provided, including: N power supply units, where N>2, wherein, each of the N power supply units is the power supply unit according to any one of the embodiments of the disclosure, and the N power supply units include a first power supply unit and a second power supply unit, and a third end of a second high-frequency isolating converter of the first power supply unit is connected to a second end of a first high-frequency isolating converter of the second power supply unit via a connection unit.

According to still another aspect of the disclosure, a power supply system is provided, including: a plurality of power supply units according to any one of the embodiments of the disclosure, wherein the first ends of the first high-frequency isolating converters of the plurality of power supply units are connected in parallel, and the first ends of the second high-frequency isolating converters of the plurality of power supply units are connected in parallel.

### BRIEF DESCRIPTION OF THE DRAWINGS

Therefore, in order to explicitly understand the features described in the disclosure, more detailed description of the above brief summarization can be obtained with reference to the embodiments. The drawings relate to the embodiments of the disclosure, and are described as follows:

FIG. 1 illustrates a power supply system in the prior art.

FIG. 2 illustrates a power supply system in the prior art.

FIG. 3A illustrates a schematic view of a power supply unit according to one embodiment of the disclosure.

FIGS. 3B-3E illustrate schematic view of energy flow of energy storage elements of a power supply unit according to one embodiment of the disclosure.

FIG. 4 illustrates a schematic view of high-frequency isolating converter in FIG. 3A.

FIG. 5 illustrates a transformer of two high-frequency isolating circuits in the high-frequency isolating converter of FIG. 4.

FIG. 6 illustrates a schematic view of the high-frequency isolating converter in FIG. 3A.

FIG. 7 illustrates a schematic view of a power supply unit according to another embodiment of the disclosure.

FIG. 8 illustrates a schematic view of a loop power supply system according to one embodiment of the disclosure.

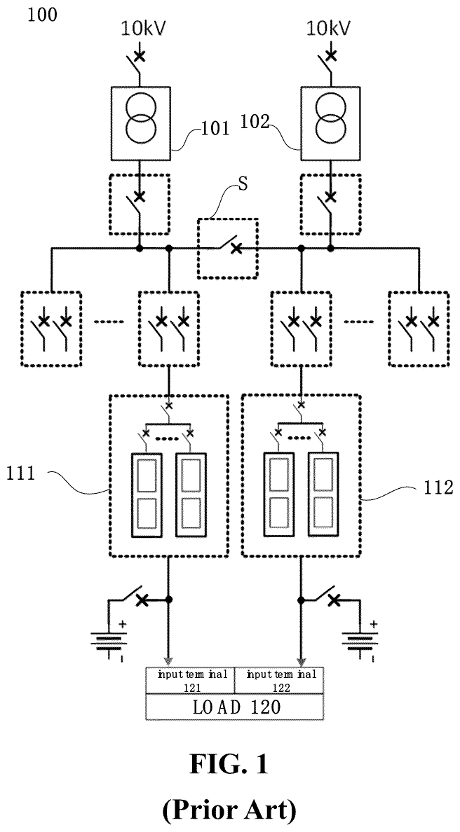

### DETAILED DESCRIPTION

Various embodiments of the disclosure shall be referred in details, one or more examples of which are illustrated in the drawings. In the description of the drawings, the same reference sign represents the same component. Hereinafter only differences of the respective embodiments are described. The examples are provided to interpret the disclosure, instead of limiting the disclosure. Moreover, as a part of one embodiment, the feature illustrated or described can be used in other embodiments, or combined with other embodiments to produce another embodiment. The specification aims to include such modifications and alternations.

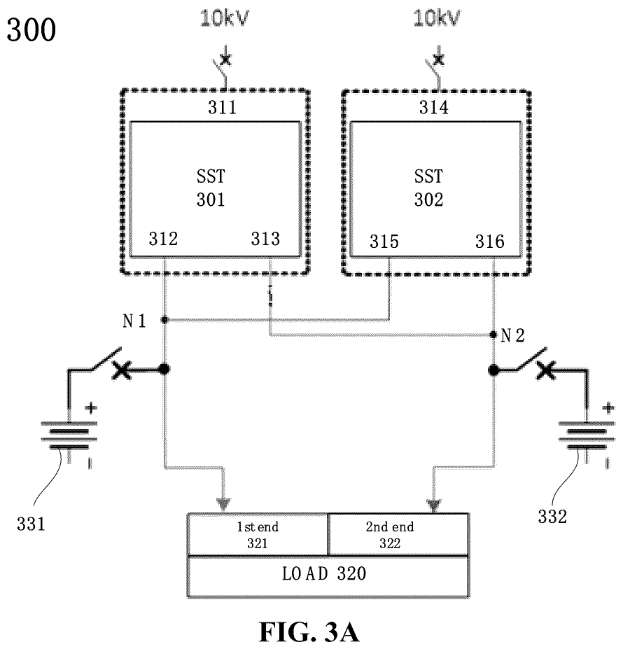

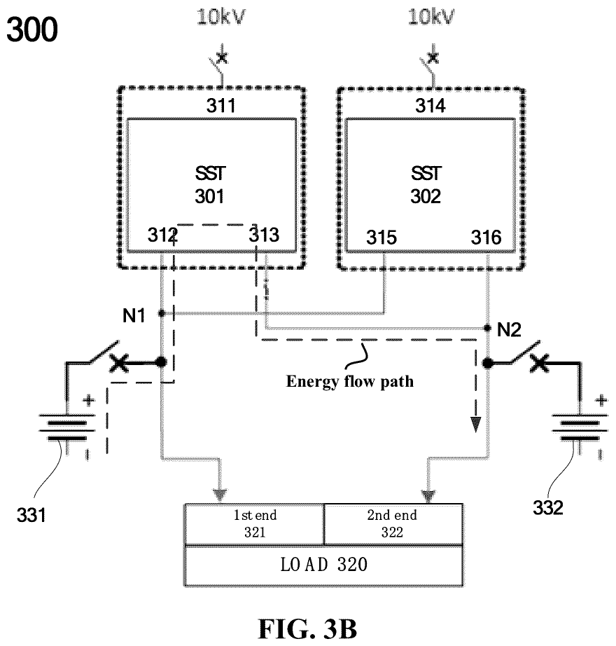

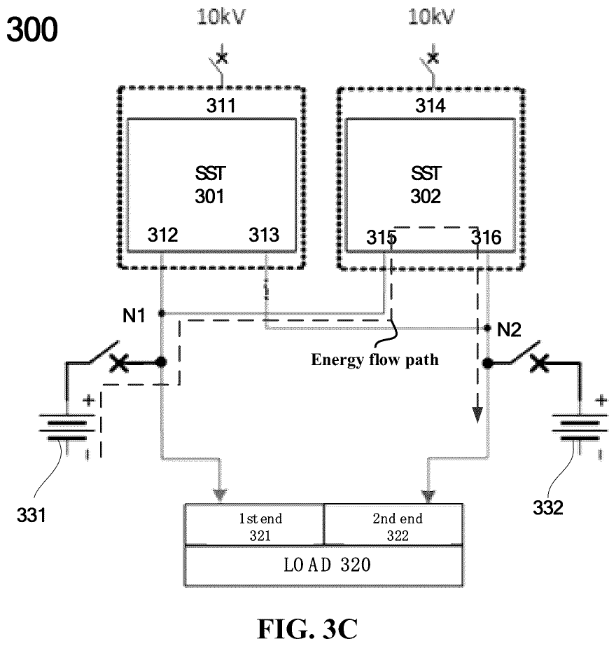

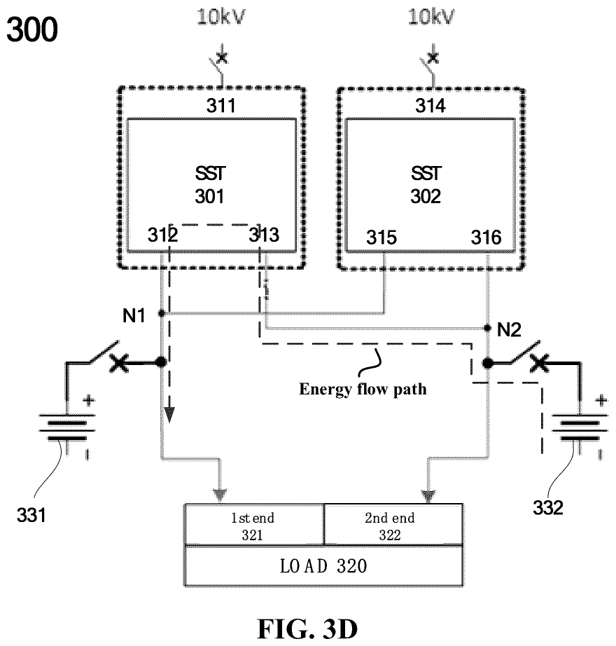

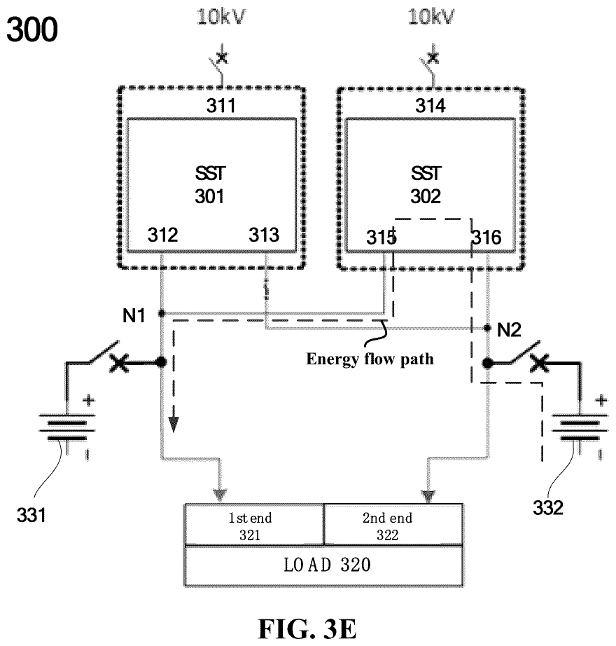

FIG. 3A illustrates a schematic view of a power supply unit 300 according to one embodiment of the disclosure. As shown in FIG. 3A, the power supply unit 300 includes two high-frequency isolating converters, such as, solid state transformers (SSTs), i.e., a first SST 301 and a second SST 302 for powering a load 320.

The first SST 301 has a first end 311, a second end 312 and a third end 313. The first end 311 of the first SST 301 receives a medium voltage AC input (e.g., a 10 KV AC voltage), and converts the medium voltage AC input into low voltage DC outputs (e.g., 270 VDC voltages) via AC-DC conversion, and the second end 312 and the third end 313 supply the converted low voltage DC outputs to a first end 321 and a second end 322 of the load 320. Therefore, the first SST 301 converts the single medium voltage AC input into two low voltage DC outputs outputted from the second end 312 and the third end 313. Similarly, the second SST 302 has a first end 314, a second end 315 and a third end 316. The first end 314 of the second SST 302 receives another medium voltage A C input (e.g., a 10 KV AC voltage), and converts the medium voltage A C input into low voltage DC outputs (e.g., 270 V DC voltages) via AC-DC conversion, and the second end 315 and the third end 316 supply the converted low voltage DC outputs to the first end 321 and the second end 322 of the load 320. Therefore, the second SST 302 converts the single medium voltage A C input into two low voltage DC outputs outputted from the second end 315 and the third end 316.

Although the two medium voltage AC inputs shown in FIG. 3A are with the same amplitude, in some other embodiments, they can also be with different amplitudes. For example, the first SST 301 may receive 10 KV medium voltage AC input, while the second SST 302 may receive 20 KV medium voltage AC input. In the case that the first SST 301 and the second SST 302 receive medium voltage AC inputs with different amplitudes, conversion circuits of the first SST 301 and the second SST 302 may have different parameters (e.g., different transformer ratios), such that the first SST 301 and the second SST 302 can still output DC outputs with the same amplitude (e.g., the 270 V DC voltage).

As shown in FIG. 3A, outputs of the first SST 301 and the second SST 302 are cross connected to power the load through the first end 321 and the second end 322 of the load 320. Specifically, the second end 312 of the first SST 301 and the second end 315 of the second SST 302 are connected to a first node N1, then they are connected to the first end 321 of the load 320, and the third end 313 of the first SST 301 and the third end 316 of the second SST 302 are connected to a second node N2, then they are connected to the second end 322 of the load 320. Therefore, the power supply unit 300 realizes 2N redundant for powering the load 320 by using two SSTs. That is, in the power supply unit 300, in the case that one of the first SST 301 and the second SST 302 has a fault, the load 320 can still be powered from both the first end 321 and the second end 322 of the load 320. For example, when the first SST 301 has a fault, since the outputs of the first SST 301 and the second SST 302 are cross connected, the load 320 still can be powered by two outputs of the SST 302 from both the first end 321 and the second end 322 of the load 320. When the second SST 302 has a fault, since the outputs of the first SST 301 and the second SST 302 are cross connected, the load 320 still can be powered by two outputs of the SST 301 from both the first end 321 and the second end 322 of the load 320.

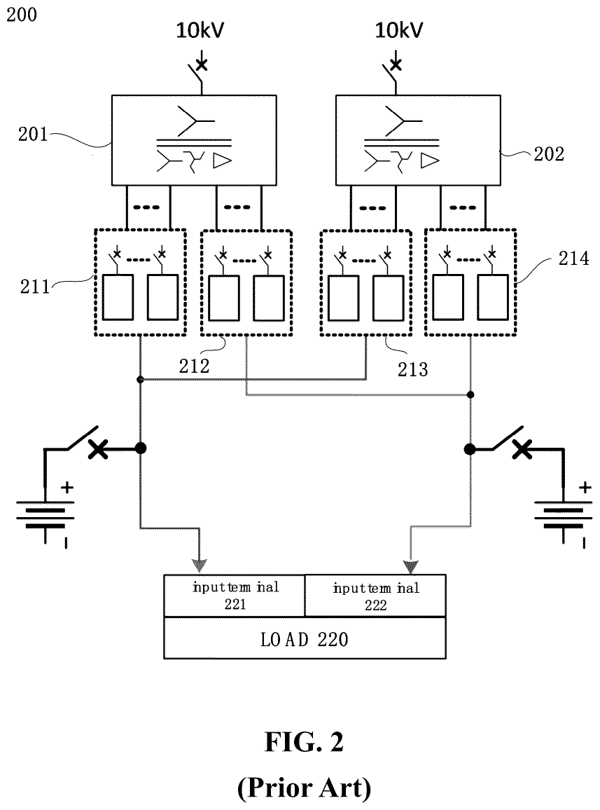

As is discussed above, after the SSTs in the power supply unit 300 receive the medium voltage AC inputs, the medium voltage AC inputs can be converted into low voltage DC outputs. As compared to the power supply system 200 discussed in FIG. 2 in which the voltages are firstly transformed by phase-shifting transformers, and then converted by AC-DC converters, it is unnecessary for the SSTs of the power supply unit 300 to use at least hundreds of low-voltage cables for connecting the phase-shifting transformers and the AC-DC converters, so the power supply unit 300 realizes a simpler and compact structure by using the SSTs, such that a footprint can be reduced by at least 50%. In addition, the SSTs may allow modularized design, so fast maintenance can be realized when faults occur, and an output benefit of a unit area of the machine room can be comprehensively enhanced by at least 10%.

In some embodiments combined with the above embodiment, the power supply unit 300 may be further provided with energy storage elements 331 and 332 (e.g., batteries) to temporarily power the load 320 when both the first SST 301 and the second SST 302 have faults or when the medium voltage AC inputs connected to the first end 311 of the first SST 301 and the first end 314 of the second SST 302 have faults. The energy storage element 331 is connected to the second end 312 of the first SST 301, the second end 315 of the second SST 302 and the first end 321 of the load 320 via a connection unit (shown as a switch), for supplying energy to the first end 321 of the load 320, and the energy storage element 332 is connected to the third end 313 of the first SST 301, the third end 316 of the second SST 302 and the second end 322 of the load 320 via a connection unit (shown as a switch), for supplying energy to the second end 322 of the load 320 via another connection unit (shown as another switch).

In some embodiments combined with the above embodiment, the second end 312 of the first SST 301 and the second end 315 of the second SST 302 are connected to a first node N1 via a connection unit (not shown), and the third end 313 of the first SST 301 and the third end 316 of the second SST 302 are connected to a second node N2 via a connection unit (not shown). The connection unit can be wire, fuse, switch or converter.

For example, in the case that the connection unit is fuse, when the first SST 301 and the second SST 302 output a large current via output terminals when having a fault (e.g., a short circuit), the fuse is fused to avoid output of the large current caused by the fault of the first SST 301 and the second SST 302 from damaging the load 320. As discussed above, even if one of the first SST 301 and the second SST 302 stops powering the load 320 due to fusing of the fuse, since the outputs of the first SST 301 and the second SST 302 are cross connected, the load 320 still can be powered from both the first end 321 and the second end 322 of the load 320 by the other one of the first SST 301 and the second SST 302 which works normally.

For example, in the case that the connection unit is a controllable switch, the controllable switch can work with sensor and controller disposed in the first SST 301 and the second SST 302. When the sensor senses that one of the first SST 301 and the second SST 302 has a fault, the controller may turn off the controllable switch associated with the SST having the fault, thereby avoiding the SST having the fault from further damaging the load 320. As discussed above, even if one of the first SST 301 and the second SST 302 stops powering the load 320 due to turning off of the controllable switch, since the outputs of the first SST 301 and the second SST 302 are cross connected, the load 320 still can be powered from both the first end 321 and the second end 322 of the load 320.

Although the above disclosures are described based on the case of different connection units, these different connection units can also be combined.

In some embodiments that can be combined with the above embodiment, the first SST 301 and the second SST 302 are each configured to enable bidirectional flow of energy between the second end and the third end of respective SST. It has been described above that the energy storage elements 331 and 332 are provided to temporarily power the load 320 when the medium voltage A C inputs connected to the first end 311 of the first SST 301 and the first end 314 of the second SST 302 have faults. In a case that any one of the energy storage elements 331 and 332 is provided, when the electrical connection between the energy storage element 331 and the first end 321 of the load 320 has faults, the energy can still be transmitted from the energy storage element 331 to the second end 312 of the first SST 301, and then to the third end 313 of the first SST 301, and finally to the second end 322 of the load 320 (shown in FIG. 3B). What's more, energy can still be transmitted from the energy storage element 331 to the second end 315 of the second SST 302, then to the third end 316 of the second SST 302, and finally to the second end 322 of the load 320 (shown in FIG. 3C). Therefore, the energy of the energy storage element 331 can be supplied to the second end 322 of the load 320 by the bidirectional energy flow between the second end and the third end of the first SST 301 and the bidirectional energy flow between the second end and the third end of the second SST 302. Similarly, when the electrical connection between the energy storage element 332 and the second end 322 of the load 320 has faults, energy can still be transmitted from the energy storage element 332 to the third end 313 of the first SST 301, and then to the second end 312 of an SST 301, and finally to the first end 321 of the load 320 (shown in FIG. 3D). What's more, energy can still be transferred from the energy storage element 332 to the third end 316 of the second SST 302, then to the second end 315 of the second SST 302, and finally to the first end 321 of the load 320 (shown in FIG. 3E). Therefore, the energy of the energy storage element 332 can be supplied to the first end 321 of the load 320 by the bidirectional energy flow between the second end and the third end of the first SST 301 and the second SST 302. Therefore, when the medium voltage AC inputs connected to the first end 311 of the first SST 301 and the first end 314 of the second SST 302 fail, and the electrical connection between one of the energy storage elements and the corresponding end of the load fails, sufficient backup time can be ensured even if the quantity of batteries for the energy storage element 331 and the quantity of batteries for the energy storage element 332 are both halved.

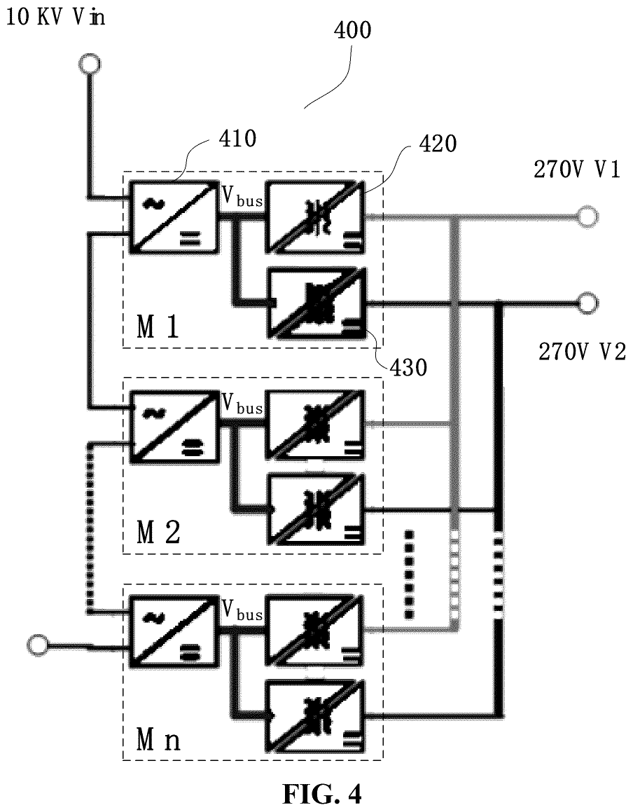

Hereinafter a specific structure of the SSTs is further described. FIG. 4 illustrates a schematic view of a high-frequency isolating converter (e.g., a SST) 400. The SST 400 in FIG. 4 can be any one of the first SST 301 and the second SST 302 in FIG. 3A.

As shown in FIG. 4, the SST 400 is formed by a plurality of modules M1, M2, . . . , Mn having the same construction. Each module has the same structure, and thus the structure of the module M1 will be described for each module. The module M1 has one rectifier 410 and two high-frequency isolating circuits 420 and 430. Primary sides of the high-frequency isolating circuits 420 and 430 are connected in parallel, and then are connected to a DC output side of the rectifier 410. The rectifier 410 receives an AC input, and converts the A C input into a DC output. Then, the high-frequency isolating circuits 420 and 430 convert the DC output into low voltage DC outputs (e.g., 270 V DC outputs). The high-frequency isolating circuit 420 outputs a first DC output (e.g., a 270 V DC output V1), and the high-frequency isolating circuit 430 outputs a second DC output (e.g., a 270 V DC output V2).

In the SST 400, AC input sides of the rectifiers 410 in the plurality of modules are connected in series to receive a medium voltage AC input, secondary sides of the high-frequency isolating circuits 420 in the plurality of modules are connected in parallel to provide the first DC output, and secondary sides of the high-frequency isolating circuits 430 in the plurality of modules are connected in parallel to provide the second DC output. Therefore, the extremely simple multi-module two-level architecture of the SST 400 realizes high efficiency of voltage conversion, and the multiple modules allow for easy maintenance.

In some embodiments that can be combined with the above embodiment, in order to achieve bidirectional energy flow between the second and third ends of the SST, the high-frequency isolating circuits 420 and 430 of each module of the SST 400 are configured as a bidirectional DC/DC conversion circuit, one side of the high-frequency isolating circuit 420 and one side of the high-frequency isolating circuit 430 are connected to the common bus V bus in parallel, the other side of the high-frequency isolating circuit 420 is connected to the first DC output (e.g., 270 V DC output V1) and powers the first end of the load, and the other side of the high-frequency isolating circuit 430 is connected to the second DC output (e.g., 270 V DC output V2) and powers the second end of the load. Similar to the case shown in FIG. 3B-FIG. 3C where the energy storage element supplies power to the second end of the load through the second end and the third end of the SST in turn, the energy of the energy storage element is output from the first DC output to the common bus Vbus through the high-frequency isolation circuit 420 with bidirectional DC/DC conversion function, and then the energy is transmitted from the common bus V bus to the second DC output through the high-frequency isolation circuit 430 with bidirectional DC/DC conversion function, to power the second end of the load. Thus, when the electrical connection between the energy storage element 331 and the first end of the load fails, the energy storage element 331 can still supply power to the second end of the load. Similar to a case shown in FIG. 3D-FIG. 3E where the energy storage element supplies power to the first end of the load through the third and second ends of the SST in turn, the high- frequency isolating circuits 420 and 430 also operate bidirectionally.

In some embodiments combined with the above embodiments, the rectifier 410 can be a full bridge rectifier or a half-bridge rectifier.

In some embodiments combined with the above embodiments, the high-frequency isolating circuits 420 and 430 realize high frequency and high efficiency by using LLC topology, and in order to pursuit a compact structure for the high-frequency isolating circuits 420 and 430, the transformer can share the same insulating board.

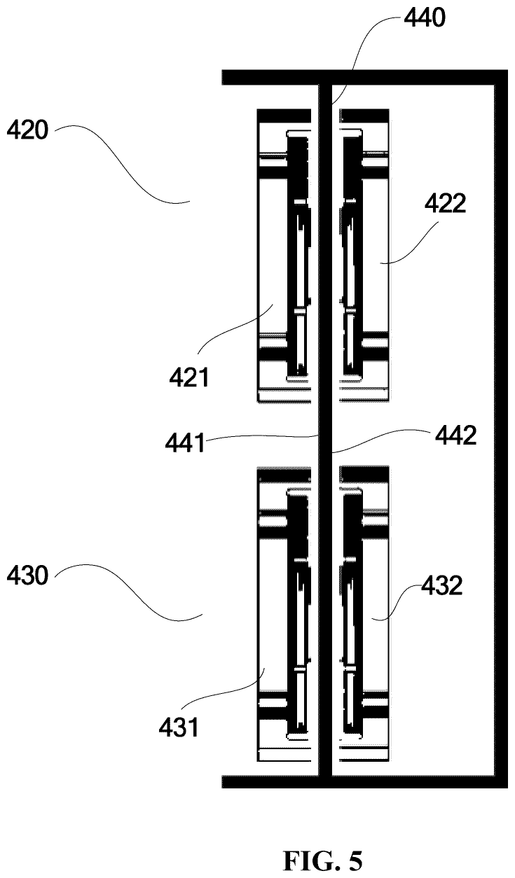

FIG. 5 illustrates arrangement of transformers of the high-frequency isolating circuits 420 and 430. As shown in FIG. 5, the transformers of the high-frequency isolating circuits 420 and 430 are disposed on an insulating board 440. A part of a magnetic core and a primary winding 421 of the transformer of the high-frequency isolating circuit 420 and a part of a magnetic core and a primary winding 431 of the transformer of the high-frequency isolating circuit 430 are disposed at a first side 441 of the insulating board 440, and another part of the magnetic core and a secondary winding 422 of the transformer of the high- frequency isolating circuit 420 and another part of the magnetic core and a secondary winding 432 of the transformer of the high-frequency isolating circuit 430 are disposed at a second side 442 of the insulating board 440, wherein the first side 441 is opposite to the second side 442. Therefore, structures of the high-frequency isolating circuits 420 and 430 that share the insulating board is more compact, and a footprint is further reduced.

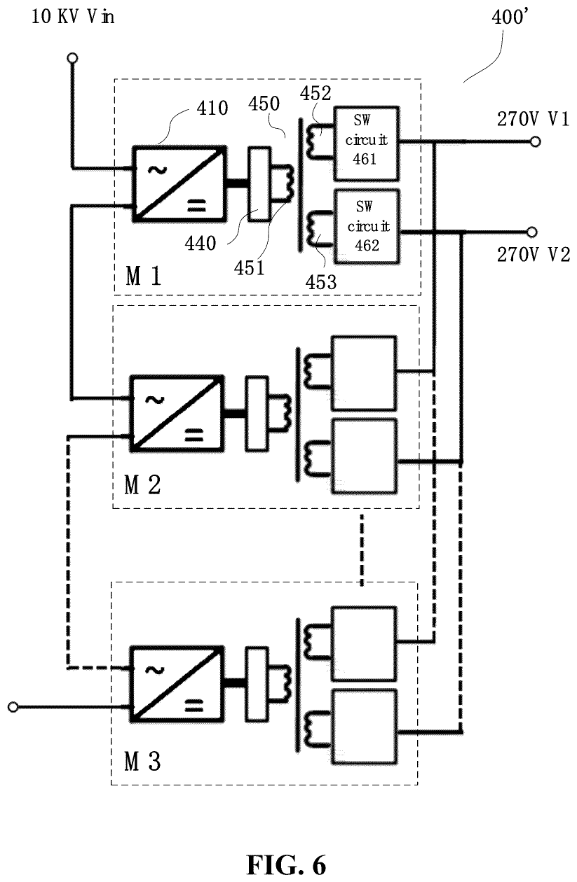

FIG. 6 illustrates a schematic view of a high-frequency isolating converter (e.g., a SST) 400′ according to another embodiment. The SST 400′ in FIG. 6 can be used for any one of the first SST 301 and the second SST 302 in FIG. 3A.

As shown in FIG. 6, the SST 400′ is formed by a plurality of modules M1, M2, . . . , M n having the same construction. Each module has the same structure, and thus the structure of the module M 1 will be described for each module. The module M1 has a rectifier 410, an inverter 440, a transformer 450 and two switching circuits 461 and 462. The rectifier 410 receives an AC input, and converts the AC input into a DC output. Then, the DC output is received by an input terminal of the inverter 440, and then converted again to an AC voltage to be sent to a primary winding 451 of the transformer 450. The transformer 450 further has two secondary windings 452 and 453 to transform the AC voltage across the primary winding 451 into two low AC voltages. The secondary winding 452 is connected to the switching circuit 461 for converting a first low AC voltage into a first low DC voltage (e.g., a 270 V V1 in FIG. 6). The secondary winding 453 is connected to the switching circuit 462 for converting a second low AC voltage into a second low DC voltage (e.g., a 270 V V2 in FIG. 6).

In the SST 400′, AC input sides of the rectifiers 410 in the plurality of modules are connected in series to receive a medium voltage AC input, output sides of the switching circuits 461 in the plurality of modules are connected in parallel to provide a first DC output, and output sides of the switching circuits 462 in the plurality of modules are connected in parallel to provide a second DC output. Therefore, the multi-module two-level architecture of the SST 400′ realizes high efficiency of voltage conversion, and the multiple modules allow for easy maintenance.

In some embodiments that can be combined with the above embodiment, in order to achieve a bidirectional energy flow between the second and third ends of the SST, in the switching circuits 461 and 462 of each module of the SST 400′, the energy can flow in both directions. The first DC output (e.g., 270 V V1 in FIG. 6) powers the first end of the load. The second DC output (e.g., 270 V V2 in FIG. 6) powers the second end 322 of the load. Similar to the case shown in FIG. 3B-FIG. 3C where the energy storage element powers the second end of the load through the second end and the third end of the SST in turn, the energy of the energy storage element is transferred from the first DC output to the winding 452 of the transformer 450 through the switching circuit 461, and then the energy is transmitted from the winding 452 to the winding 453 due to the coupling of the windings 453 and 452, and finally the energy is transmitted to the second DC output through the switching circuit 462 and powers the second end of the load. Thus, when the electrical connection between the energy storage element 311 and the first end of the load fails, the energy storage element 311 can still powers the second end of the load. Similar to the case shown in FIG. 3D-FIG. 3E where the energy storage element supplies power to the first end of the load through the third and second ends of the SST in turn, the switching circuits 462 and 463 also operate bidirectionally.

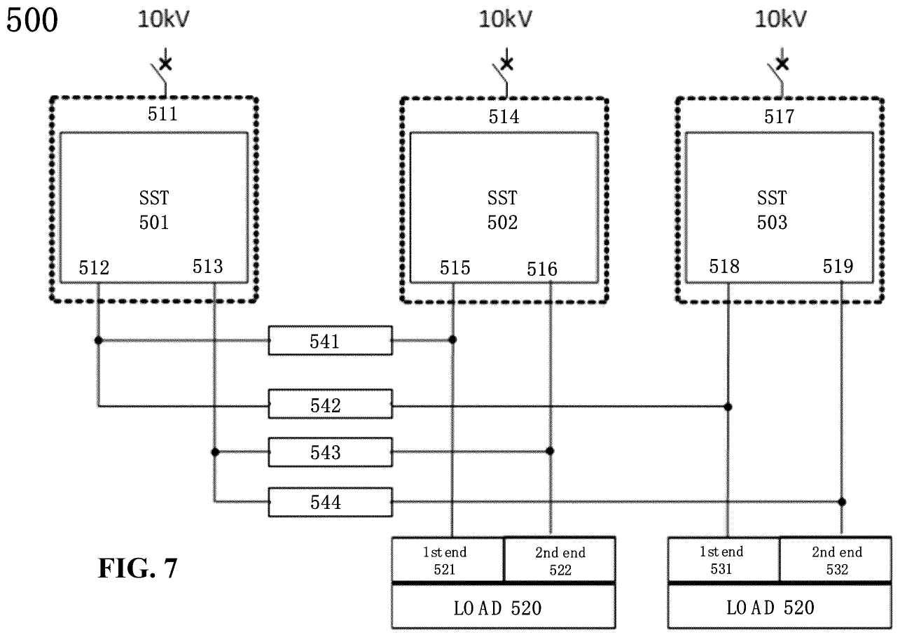

FIG. 7 illustrates a schematic view of a power supply unit 500 according to another embodiment of the disclosure. The power supply unit 500 includes three high-frequency isolating converters, such as, SSTs, i.e., a first SST 501, a second SST 502 and a third SST 503 for powering two loads 520 and 530.

The first SST 501 has a first end 511, a second end 512 and a third end 513. The first end 511 of the first SST 501 receives a medium voltage AC input (e.g., a 10 KV AC voltage), and converts the medium voltage AC input into low voltage DC outputs (e.g., 270 V DC voltages) outputted from the second end 512 and the third end 513 via AC-DC conversion. Similarly, the second SST 502 has a first end 514, a second end 515 and a third end 516. The first end 514 of the second SST 502 receives a medium voltage A C input (e.g., a 10 KV AC voltage), and converts the medium voltage AC input into low voltage DC outputs (e.g., 270 V DC voltages) outputted from the second end 515 and the third end 516 via AC-DC conversion. Similarly, the third SST 503 has a first end 517, a second end 518 and a third end 519. The first end 517 of the third SST 503 receives a medium voltage AC input (e.g., a 10 KV AC voltage), and converts the medium voltage AC input into low voltage DC outputs (e.g., 270 V DC voltages) outputted from the second end 518 and the third end 519 via AC-DC conversion.

Although the SSTs 501 to 503 illustrated in FIG. 7 receive the medium voltage A C inputs with the same amplitude (e.g., the 10 KV AC voltage), alternatively, the amplitudes of the medium voltage A C inputs received by the first SST 501, the second SST 502 and the third SST 503 may be different from each other. In such case, conversion circuits in the first SST 501, the second SST 502 and the third SST 503 may have different parameters (e.g., different transformer ratios), such that the first SST 501, the second SST 502 and the third SST 503 still output DC outputs with the same amplitude (e.g., the 270 V DC voltage).

As shown in FIG. 7, outputs of the first SST 501, the second SST 502 and the third SST 503 can be divided into two groups of DC outputs, one group powers a first end 521 and a second end 522 of the load 520, and another group powers a first end 531 and a second end 532 of the load 530. Specifically, the second end 512 of the first SST 501 and the second end 515 of the second SST 502 are connected to a first node N1, and then connected to the first end 521 of the load 520 for powering the load 520. The third end 513 of the first SST 501 and the third end 516 of the second SST 502 are connected to a second node N2, and then connected to the second end 522 of the load 520 for powering the load 520. The second end 512 of the first SST 501 and the second end 518 of the third SST 503 are connected to a third node N3, and then connected to the first end 531 of the load 530 for powering the load 530. The third end 513 of the first SST 501 and the third end 519 of the third SST 503 are connected to a fourth node N4, and then connected to the second end 532 of the load 530 for powering the load 530. Therefore, the power supply unit 500 realizes redundant powering for the two loads 520 and 530 by using three SSTs.

In the power supply unit 500, in the case that one of the first SST 501, the second SST 502 and the third SST 503 has a fault, each of the two loads 520 and 530 still can be powered through its first end and second end. For example, when the first SST 501 has a fault, since outputs of the first SST 501, the second SST 502 and the third SST 503 are cross connected, the load 520 still can be powered from both the first end 521 and the second end 522 of the load 520 by the second SST 502, and the load 530 still can be powered from both the first end 531 and the second end 532 of the load 530 by the third SST 503. It happens the same way when the second SST 502 or the third SST 503 has fault.

In some embodiment combined with the above embodiments, although not illustrated, similarly with the power supply unit 300 discussed in FIG. 3A, the power supply unit 500 may be further provided with energy storage elements to temporarily power the loads 520 and 530 when two or three of the first SST 501, the second SST 502 and the third SST 503 have the faults.

In some embodiment combined with the above embodiments, similarly with the power supply unit 300 discussed in FIG. 3A, as shown in FIG. 7, the second end 512 of the first SST 501 is connected to the second end 515 of the second SST 502 via a connection unit 541, the third end 513 of the first SST 501 is connected to the third end 516 of the second SST 502 via a connection unit 543, the second end 512 of the first SST 501 is connected to the second end 518 of the third SST 503 via a connection unit 542, and the third end 513 of the first SST 501 is connected to the third end 519 of the third SST 503 via a connection unit 544. These connection units can be wires, fuses, switches or converters, and function the same as the connection units in the power supply unit 300 discussed in FIG. 3A, so the details are not described here again.

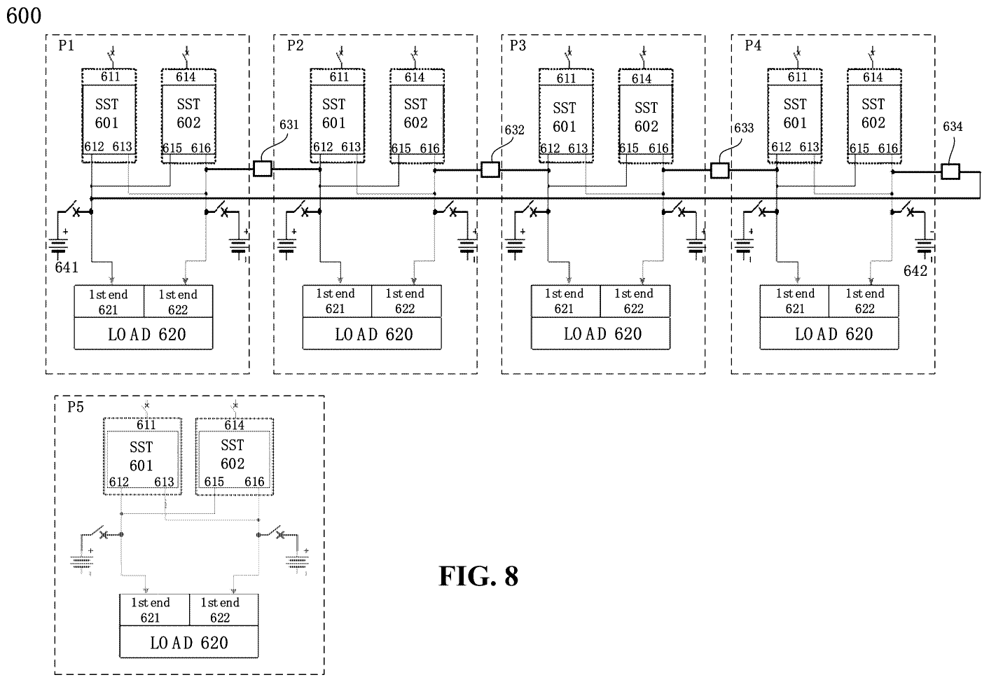

FIG. 8 illustrates a schematic view of a power supply system 600 according to one embodiment of the disclosure. The power supply system includes N power supply units, where N is greater than or equal to 2. For example, the power supply system illustrated in FIG. 8 includes four power supply units. Structure of each power supply unit is the same as that of the power supply unit 300 discussed in FIG. 3A. For example, the power supply unit P1 includes two high-frequency isolating converters, such as, SSTs, i.e., a first SST 601 and a second SST 602 for powering a load 620. The first SST 601 has a first end 611, a second end 612 and a third end 613. The first end 611 of the first SST 601 receives a medium voltage AC input (e.g., a 10 KV AC voltage), and converts the medium voltage A C input into low voltage DC outputs (e.g., 270 V DC voltages) via AC-DC conversion, and the second end 612 and the third end 613 supply the converted low voltage DC outputs to a first end 621 and a second end 622 of the load 620. Therefore, the first SST 601 converts the single medium voltage AC input into two low voltage DC outputs outputted from the second end 612 and the third end 613. Similarly, the second SST 602 has a first end 614, a second end 615 and a third end 616. The first end 614 of the second SST 602 receives another medium voltage AC input (e.g., a 10 KV AC voltage), and converts the medium voltage AC input into low voltage DC outputs (e.g., 270 V DC voltages) via AC-DC conversion, and the second end 615 and the third end 616 supply the converted low voltage DC outputs to the first end 621 and the second end 622 of the load 620. Therefore, the first SST 601 converts the single medium voltage AC input into two low voltage DC outputs outputted from the second end 615 and the third end 616. In addition, the power supply unit P1 may also have the same connection units and the energy storage elements as in the power supply unit 300 discussed in FIG. 3A. Power supply units P2, P3 and P4 have the same structure as the power supply unit P1.

In the power supply system 600, at least two power supply units are connected through connection units. For example, as for the power supply units P1 and P2, the third end 616 of the second SST 602 in the power supply unit P1 and the second end 612 of the first SST 601 in the power supply unit P2 are connected in parallel via a connection unit 631. For another example, as for the power supply units P2 and P3, the third end 616 of the second SST 602 in the power supply unit P2 and the second end 612 of the first SST 601 in the power supply unit P3 are connected in parallel via a connection unit 632. For another example, as for the power supply units P3 and P4, the third end 616 of the second SST 602 in the power supply unit P3 and the second end 612 of the first SST 601 in the power supply unit P4 are connected in parallel via a connection unit 633.

In the power supply system 600, additionally or alternatively, at least three power supply units are connected through connection units. For example, as for the power supply units P1, P2 and P3, the third end 616 of the second SST 602 in the power supply unit P1 and the second end 612 of the first SST 601 in the power supply unit P2 are connected via the connection unit 631, and the third end 616 of the second SST 602 in the power supply unit P2 and the second end 612 of the first SST 601 in the power supply unit P3 are connected via the connection unit 632. For another example, as for the power supply units P2, P3 and P4, the third end 616 of the second SST 602 in the power supply unit P2 and the second end 612 of the first SST 601 in the power supply unit P3 are connected via the connection unit 632, and the third end 616 of the second SST 602 in the power supply unit P3 and the second end 612 of the first SST 601 in the power supply unit P4 are connected via the connection unit 633.

In the power supply system 600, additionally or alternatively, the first power supply unit P1 and the last power supply unit P4 may be connected through a connection unit. For example, the third end 616 of the second SST 602 in the power supply unit P4 and the second end 612 of the first SST 601 in the power supply unit P1 are connected via a connection unit 634, such that the 4 power supply units have a substantially ring-shaped connection architecture. The quantity of the power supply units is not limited to 4.

In the power supply system 600, additionally or alternatively, the first end 611 of the first SST 601 of each of the power supply units P1, P2, P3 and P4 may be connected in parallel to receive a medium voltage AC input, and the first end 614 of the second SST 602 of each of the power supply units P1, P2, P3 and P4 may be connected in parallel to receive another medium voltage AC input.

The loop power supply system 600 with such connection forms a redundant power supply system for powering the load of each power supply unit, and only if there is no fault in three adjacent SSTs, the loop power supply system 600 can provide two outputs for all loads. For example, in the case that two SSTs in the power supply unit P2 have faults, the third end 616 of the second SST 602 in the power supply unit P1 can continue to power the first end 621 of the load 620 in the power supply unit P2, and the second end 612 of the first SST 601 in the power supply unit P3 can continue to power the second end 622 of the load 620 in the power supply unit P2. That is, even if two SSTs in one power supply unit both have faults, the load of the power supply unit having the faults can be powered from the first end and the second end of the load by other power supply units connected to the power supply units having the faults.

In some embodiments combined with the above embodiments, the loop power supply system 600 may be further provided with one or more additional power supply units independent of (i.e., no electrical connection) the N power supply units which form a loop. For example, the power supply system 600 may be further provided with a power supply unit P5 independent of the power supply units P1, P2, P3 and P4 which form a loop. As shown in FIG. 8, construction of the power supply unit P5 can be similar with that of the power supply unit 300 discussed in FIG. 3A. Structure of the power supply unit P5 can also be similar with that of the power supply unit 500 discussed in FIG. 7.

In the power supply system shown in FIG. 8, it is also possible that the first SST 301 and the second SST 302 are each configured to enable bidirectional energy flow between the second end and the third end of the respective SST. If the path from the battery 641 to the first end 621 of the load 620 in the power supply unit P1 breaks down, the battery 641 can power the load 620 with the second end 622 of the load 620 by allowing energy to flow bidirectionally between the second and third ends of the same SST, and the battery 642 in the power supply unit P4 can also power the load 620 from the second end 622 of the load 620. In this way, when the medium voltage AC inputs fail and the path from one battery to the corresponding load breaks down, sufficient backup time can be ensured even when the quantity of the battery connecting to the first end of the corresponding load and the quantity of battery connecting to the second end of the corresponding load are both halved.

In the above embodiments, explanations are made taking energy flowing from a medium voltage AC input to a DC load for example. In some other embodiments, energy can also flow from the DC load to the medium voltage A C input.

To sum up, the power supply unit provided in the disclosure realizes a simpler and compact structure by using the high-frequency isolating converters, such that a footprint can be reduced. In addition, the high-frequency isolating converters may allow modularized design, so medium voltage input of the high-frequency isolating converters having faults can be disconnected, thereby realizing a cold plugboard and fast maintenance, and comprehensively enhancing an output benefit of a unit area of the machine room. By connecting the power supply units to form a loop using the connection units, even if the two high-frequency isolating converters in one power supply unit both have faults, the load of the power supply units having faults can be powered from both the first end and second end of the load by the high-frequency isolating converter in other power supply units adjacent to the power supply units having faults, thereby improving reliability of the power supply system.

Although the disclosures are directed to the embodiments of the disclosure, other and further embodiments of the disclosure can also be designed in the case of not departing from the basic scope of the disclosure, and the scope of the disclosure is determined by the appended claims.

What is claimed is:

1. A power supply unit, comprising:
a first high-frequency isolating converter comprising a first port connected to a first voltage, a second port and a third port; and
a second high-frequency isolating converter comprising a first port connected to a second voltage, a second port and a third port, wherein the second port of the second high-frequency isolating converter and the second port of the first high-frequency isolating converter are connected in parallel to a first port of a first load to supply power to the first port of the first load, and the third port of the second high-frequency isolating converter and the third port of the first high-frequency isolating converter are connected in parallel to a second port of the first load to supply power to the second port of the first load, and
when one high-frequency isolating converter of the first high-frequency isolating converter and the second high-frequency isolating converter fails, the first and the second port of the first load are respectively powered by the second port and the third port of the other high-frequency isolating converter of the first high-frequency isolating converter and the second high-frequency isolating converter.

2. The power supply unit according to claim 1, wherein the second port of the first high-frequency isolating converter is connected in parallel to the second port of the second high-frequency isolating converter via a first connection unit, and the third port of the first high-frequency isolating converter is connected in parallel to the third port of the second high-frequency isolating converter via a second connection unit.

3. The power supply unit according to claim 2, wherein the connection unit comprises wire, fuse, switch or converter.

4. The power supply unit according to claim 1, further comprising a first energy storage element electrically connected to the first port of the first load via a connection unit, and a second energy storage element electrically connected to the second port of the first load via another connection unit.

5. The power supply unit according to claim 1, wherein each of the first high- frequency isolating converter and the second high-frequency isolating converter comprises a plurality of modules, each of the plurality of modules comprising:
a first port, wherein the first ports of the plurality of modules are connected in series to couple to the first port of the high-frequency isolating converter;
a second port, wherein the second ports of the plurality of modules are connected in parallel to couple to the second port of the high-frequency isolating converter; and
a third port, wherein the third ports of the plurality of modules are connected in parallel to couple to the third port of the high-frequency isolating converter.

6. The power supply unit according to claim 5, wherein each module comprising:
a rectifier comprising a first port and a second port, wherein the first port of the rectifier power supply is connected to the first port of the module;
a first high-frequency isolating circuit having a first port connected to the second port of the rectifier, and a second port connected to the first port of the first load, wherein the second port of the first high-frequency isolating circuit is connected to the second port of the module; and
a second high-frequency isolating circuit having a first port connected in parallel to the first port of the first high-frequency isolating circuit, and a second port connected to the second port of the first load, wherein the second port of the second high-frequency isolating circuit is connected to the third port of the module.

7. The power supply unit according to claim 6, wherein the rectifier is a full bridge rectifier or a half-bridge rectifier.

8. The power supply unit according to claim 6, wherein in each of the plurality of modules,
the first high-frequency isolating circuit and the second high-frequency isolating circuit share an insulating board,
the first high-frequency isolating circuit comprises a first transformer, and the second high-frequency isolating circuit comprises a second transformer,
each of the first transformer and the second transformer comprises a magnetic core, a primary winding and a secondary winding,
a part of the magnetic cores and the primary windings of the first transformer and the second transformer are disposed on a first side of the insulating circuit board, and
another part of the magnetic cores and the secondary windings of the first transformer and the second transformer are disposed on a second side opposite to the first side of the insulating board.

9. The power supply unit according to claim 5, wherein each module comprising:
a first rectifier comprising a first port and a second port, wherein the first port of the first rectifier circuit is connected to the first port of the module;
an inverter having a first port connected to the second port of the first rectifier, a transformer comprising a primary winding connected to a second port of the inverter, and two secondary windings; and
two second switching circuits connected to the two secondary windings respectively, wherein one of the two second switching circuits is connected to the first port of the first load through the second port of the module, and the other of the two second switching circuits is connected to the second port of the first load through the third port of the module.

10. The power supply unit according to claim 1, wherein each of the first voltage and the second voltage is 10 kV AC voltage.

11. The power supply unit according to claim 1, wherein the first high-frequency isolating converter and the second high-frequency isolating converter are configured to enable bidirectional flow of energy between the second port and the third port of the respective high-frequency isolating converter.

12. The power supply unit according to claim 11, further comprising a first energy storage element electrically connected to the first port of the first load, the second port of the first high-frequency isolating converter and the second port of second high-frequency isolating converter, wherein the first high-frequency isolating converter and the second high-frequency isolating converter are configured such that:
an energy from the first energy storage element is transmitted from the second port of the first high-frequency isolating converter to the second port of the first load via the third port of the first high-frequency isolating converter, or
an energy from the first energy storage element is transmitted from the second port of the second high-frequency isolating converter to the second port of the first load via the third port of the second high-frequency isolating converter.

13. The power supply unit according to claim 11, further comprising a second energy storage element electrically connected to the second port of the first load, the third port of the first high-frequency isolating converter and the third port of second high-frequency isolating converter, wherein the first high-frequency isolating converter and the second high-frequency isolating converter are configured such that:
an energy from the second energy storage element is transmitted from the third port of the first high-frequency isolating converter to the first port of the first load via the second port of the first high-frequency isolating converter, or
an energy from the second energy storage element is transmitted from the third port of the second high-frequency isolating converter to the first port of the first load via the second port of the second high-frequency isolating converter.

14. The power supply unit according to claim 2, further comprising:
a third high-frequency isolating converter comprising a first port connected to a third voltage, a second port and a third port,
the second port of the first high-frequency isolating converter and the second port of the third high-frequency isolating converter are connected in parallel to a first port of a second load via a third connection unit, and the third port of the first high-frequency isolating converter and the third port of the third high-frequency isolating converter are connected in parallel to a second port of the second load via a fourth connection unit.

15. A power supply system, comprising:
N power supply units, where N>2, wherein,
each of the N power supply units is the power supply unit according to claim 1, and
the N power supply units comprise a first power supply unit and a second power supply unit, and a third port of a second high-frequency isolating converter of the first power supply unit is connected to a second port of a first high-frequency isolating converter of the second power supply unit via a connection unit.

16. The power supply system according to claim 15, wherein,
a second port of the first high-frequency isolating converter of the i-th power supply unit in the N power supply units is connected in parallel to a third port of the first high-frequency isolating converter of the (i−1)th power supply unit in the N power supply units via a fifth connection unit, and a third port of the first high-frequency isolating converter of the i-th power supply unit in the N power supply units is connected in parallel to a second port of the first high-frequency isolating converter of the (i+1)th power supply unit in the N power supply units via a sixth connection unit, where 2<i≤N−1, and
a second port of the first high-frequency isolating converter of the first power supply unit in the N power supply units is connected in parallel to a third port of the first high-frequency isolating converter of the N-th power supply unit in the N power supply units via a seventh connection unit.

17. The power supply system according to claim 15, wherein,
the N power supply units comprise M power supply units, where M<N;
a second port of the first high-frequency isolating converter of the i-th power supply unit in the M power supply units is connected in parallel to a third port of the first high-frequency isolating converter of the (i−1)th power supply unit in the M power supply units via a fifth connection unit, and a third port of the first high-frequency isolating converter of the i-th power supply unit in the M power supply units is connected in parallel to a second port of the first high-frequency isolating converter of the (i+1)th power supply unit in the M power supply units via a sixth connection unit, where 2≤i≤M−1; and
the second port of the first high-frequency isolating converter of the first power supply unit in the M power supply units is connected in parallel to the third port of the first high-frequency isolating converter of the M-th power supply unit in the M power supply units via a seventh connection unit.

18. The power supply system according to claim 15, further comprising one or more additional power supply units independent of the N power supply units, wherein a configuration of each of the one or more additional power supply units is the same as that of each of the N power supply units.

19. The power supply system according to claim 15, wherein first ports of the first high-frequency isolating converters of the N power supply units are connected in parallel, and first ports of the second high-frequency isolating converters of the N power supply units are connected in parallel.

20. A power supply system, comprising:
a plurality of power supply units according to claim 1, wherein first ports of the first high-frequency isolating converters of the plurality of power supply units are connected in parallel, and first ports of the second high-frequency isolating converters of the plurality of power supply units are connected in parallel.
